(19) United States
(12) Patent Application Publication
(10) Pub. No.: US 2021/0300660 A1
(43) Pub. Date: Sep. 30, 2021

(54) THERMAL REGULATING DEVICES WITH CONDENSATION MITIGATION

(71) Applicant: WestRock MWV, LLC, Atlanta, GA (US)

(72) Inventors: Trisha J. Massenzo, Richmond, VA (US); David J. Wiemann, Chesterfield, MO (US)

(73) Assignee: WestRock MWV, LLC, Atlanta, GA (US)

(21) Appl. No.: 17/165,863

(22) Filed: Feb. 2, 2021

Related U.S. Application Data
(63) Continuation-in-part of application No. 16/791,228, filed on Feb. 14, 2020.

(51) Int. Cl. B65D 81/18; B65D 81/38; B32B 5/02; B32B 3/28; B32B 29/00; B32B 27/10; B32B 29/02; B32B 27/34

(52) U.S. Cl. CPC B65D 81/18; B65D 81/3897; B32B 5/02; B32B 3/28; B32B 29/005; B32B 2439/46; B32B 29/02; B32B 27/34; B32B 2262/0284; B32B 2307/304; B32B 2307/726; B32B 27/10

(57) ABSTRACT

A thermal regulating device can include an insulated envelope configured to contain a thermal element therein to reduce thermal transfer between the thermal element and the atmosphere. The insulated envelope can include a condensation barrier configured to block formation of condensation or to absorb condensation. The insulated envelope can include an outer liner and an insulating material disposed within the outer liner.

### CROSS-REFERENCE TO RELATED APPLICATIONS

This application claims priority to and the benefit of U.S. Non-Provisional application Ser. No. 16/791,228, filed Feb. 14, 2020, the entire contents of which are herein incorporated by reference in their entirety.

### FIELD

This disclosure relates to thermal regulating devices, e.g., for shipping thermally sensitive items.

### BACKGROUND

Packages can be used to transport items that require thermal control within the package. For cool items, traditionally gel packs are used for ambient range goods (e.g., chocolate). For colder items, dry ice can be directly dropped in the shipping package. A heating element can also be utilized in the package to keep hot items that are shipped warm. In many instances, condensation can form on or within certain packages, potentially compromising the package structure

Such conventional methods and systems have generally been considered satisfactory for their intended purpose. However, there is still a need in the art for improved thermal control devices. The present disclosure provides a solution for this need.

### SUMMARY

A thermal regulating device can include an insulated envelope configured to contain a thermal element therein to reduce thermal transfer between the thermal element and the atmosphere. The insulated envelope can include a condensation barrier configured to block formation of condensation or to absorb condensation. The insulated envelope can include an outer liner and an insulating material disposed within the outer liner.

In certain embodiments, the insulating material and/or the outer liner can be the condensation barrier. An amount of the insulating material can be selected to control temperature of the outer liner and/or rate of heat transfer to the thermal element. The liner can be a natural and/or synthetic material. The liner can be a flexible paper liner (e.g., kraft liner). In certain embodiments, the insulating material can be polyethylene (PE) (configured to act as a condensation barrier).

In certain embodiments, the condensation barrier can include a first layer, a second layer, and middle layer between the first and second layer. The first layer and second layer can be a film (e.g., hydrophobic), and the middle layer can be spun PET fibers. In certain embodiments, the first layer and second layer can be coated (e.g., with hydrophobic material) liner (e.g., kraft liner or nylon), and the middle layer can be corrugated medium. In certain embodiments, the first layer and second layer can be coated (e.g., with hydrophobic material) liner, and the middle layer can be a fiberized insulating material. Any other suitable sandwich assembly is contemplated herein.

In certain embodiments, the condensation barrier can be a condensation absorbing layer. The condensation absorbing layer can include a first liner, a second liner, and an absorptive material disposed between the first liner and the second liner. In certain embodiments, the absorptive material can include a superabsorbent polymer. The thermal regulating device can include any other suitable characteristics of any suitable embodiment(s) disclosed herein, e.g., described below.

In accordance with at least one aspect of this disclosure, a method can include insulating a thermal element within an insulated package having a condensation barrier, and placing the insulated package within a shipping container to regulate a temperature within the shipping container for at least a predetermined amount of time while preventing condensation from forming within the package due to the condensation barrier. The thermal element can be dry ice. Placing the insulated package can include placing the insulated package at a bottom of the shipping container.

These and other features of the embodiments of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a perspective view of an embodiment of a package in accordance with this disclosure, showing an embodiment of an envelope in accordance with this disclosure disposed within a shipping package having a thermally reflective layer;

FIG. 2 is a perspective view of an embodiment of a package in accordance with this disclosure, showing an embodiment of an envelope in accordance with this disclosure disposed within a shipping package without a thermally reflective layer;

FIG. 3 is a perspective view of the embodiment of an envelope of FIGS. 1 and 2, shown open at an end thereof and having a thermal element and an insulating material disposed therein;

FIG. 3A is a cross-sectional view of the embodiment of FIG. 3;

FIG. 3B is a cross-sectional view of the embodiment of FIG. 3, shown having a larger thermal element and little to no dead space;

FIG. 3C shows an embodiment of a configuration of a shipper in accordance with this disclosure;

FIG. 3D shows an embodiment of a configuration of a shipper in accordance with this disclosure;

FIG. 4 is a perspective view of an embodiment of a package for containing a thermal element in accordance with this disclosure;

FIG. 5A is a perspective view of an embodiment of a package for containing a thermal element in accordance with this disclosure;

FIG. 5B is a cross-sectional side view of an embodiment of a shipping packaged in accordance with this disclosure, shown having the package of FIG. 5A disposed therein;

FIG. 6-16 are charts showing experimental data of one or more embodiments of this disclosure;

FIG. 17 shows a partial cross-sectional view of an embodiment of a condensation barrier in accordance with this disclosure, shown having spun PET fiber layer and a film disposed on both sides of the spun PET layer;

FIG. 18 shows a partial cross-sectional view of an embodiment of a condensation barrier in accordance with this disclosure, shown having a corrugated medium layer, a paper liner layer on both sides of the corrugated medium layer, and a coating on each paper liner layer;

FIG. 19 shows a partial cross-sectional view of an embodiment of a condensation barrier in accordance with this disclosure, shown having a fiberized material layer, a paper liner layer on both sides of the fiberized material layer, and a coating on each paper liner layer;

FIG. 20 shows a partial cross-sectional view of an embodiment of a condensation barrier in accordance with this disclosure, shown being a polyethylene (PE) foam;

FIG. 21 shows a partial cross-sectional view of an embodiment of a condensation barrier in accordance with this disclosure, shown having a super absorbent polymer (SAP) layer and a paper liner layer on each side of the SAP layer;

FIG. 22A shows a perspective view of an embodiment of an envelope made of the embodiment of a condensation barrier of FIG. 17;

FIG. 22B shows a perspective view of the embodiment of FIG. 22A, showing an opening of the envelope;

FIG. 23A shows an embodiment of an envelope made of the embodiment of a condensation barrier of FIG. 20; and

FIG. 23B shows a perspective view of the embodiment of FIG. 23A, showing an opening of the envelope.

### DETAILED DESCRIPTION

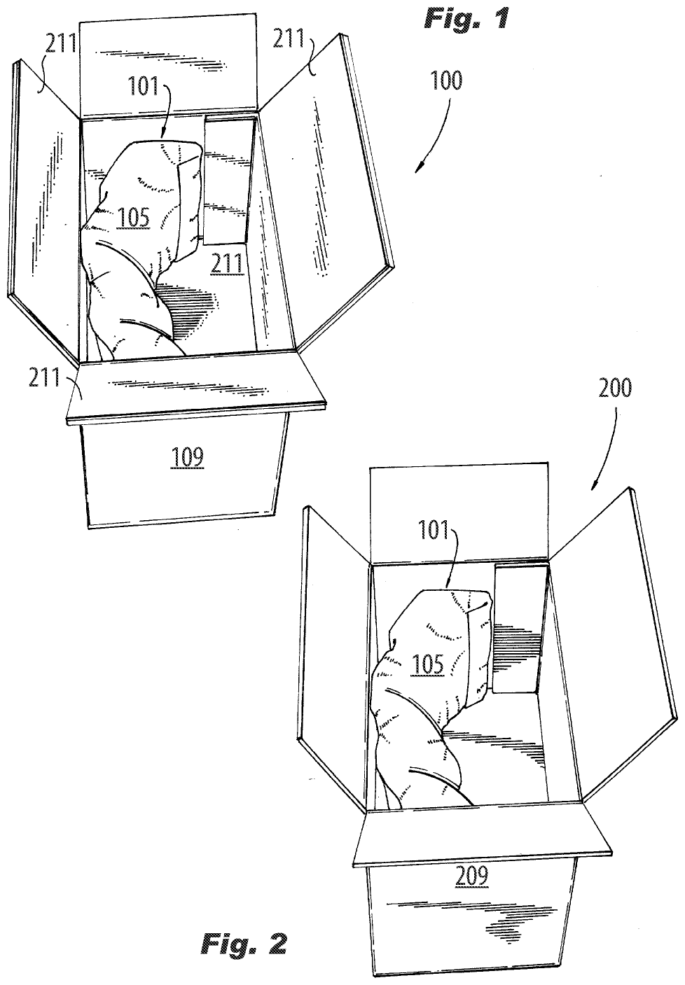

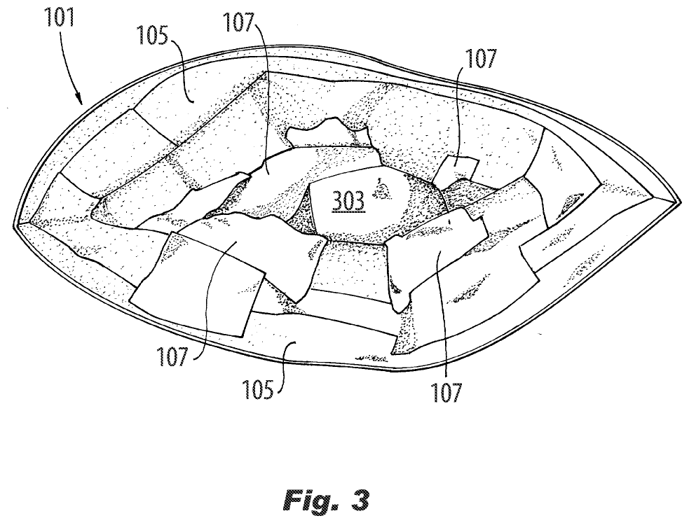

Reference will now be made to the drawings wherein like reference numerals identify similar structural features or aspects of the subject disclosure. For purposes of explanation and illustration, and not limitation, an illustrative view of an embodiment of a package in accordance with the disclosure is shown in FIG. 1 and is designated generally by reference character 100. Other embodiments and/or aspects of this disclosure are shown in FIGS. 2-23B. Certain embodiments described herein can be used to improve thermal controlled shipping, for example.

Referring to FIGS. 1-3, a package 100, 200 can include a thermal regulating device 101, for example. A thermal regulating device 101 can include an insulated envelope 101a configured to contain a thermal element 303 therein to reduce thermal transfer between the thermal element 303 and the atmosphere (e.g., air in a shipping package). The insulated envelope 101a can include an outer liner 105 and an insulating material 107 disposed within the outer liner 105. An amount of the insulating material 107 can be selected to control temperature of the outer liner 105 and/or a rate of heat transfer to the thermal element 303 (e.g., from the atmosphere). For example, an amount of insulation in an envelope for ambient applications may be more than for frozen applications, for example (e.g., to ensure sufficient cooling action). As used herein, the term “envelope” can be any suitable enclosure, e.g., a flexible pouch, a rigid box, and/or any other suitable structure.

The liner 105 can include any suitable natural and/or synthetic materials. For example, in certain embodiments, the liner 105 can include at least one of paper (e.g., kraft), a board (e.g., paperboard, corrugate), a plastic (a flexible plastic, corrugate), or nylon. For example, the liner 105 can be a flexible paper liner (e.g., kraft liner) or any other thin sheet material. Any other suitable material is contemplated herein. A thickness of the liner 105 can be selected to control heat transfer to produce a certain loss of thermal power of the thermal element, for example.

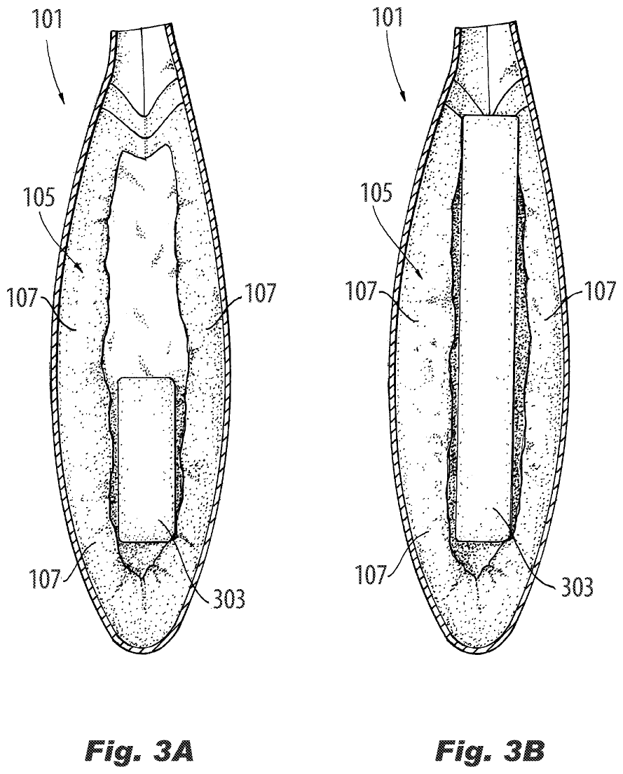

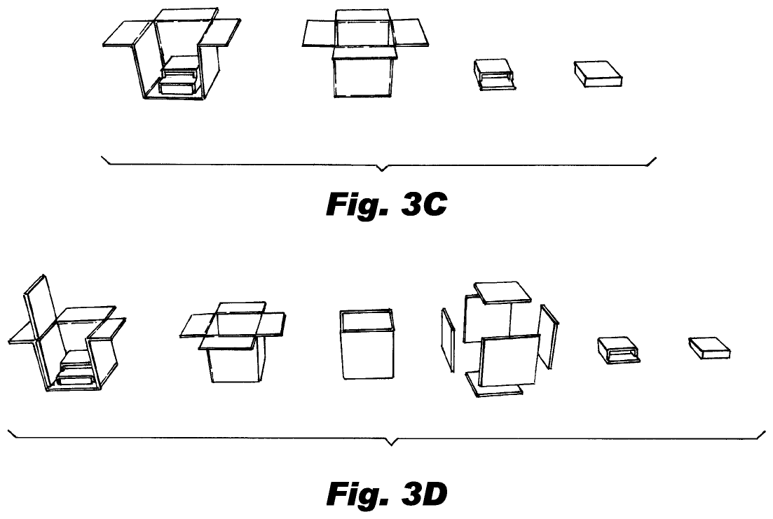

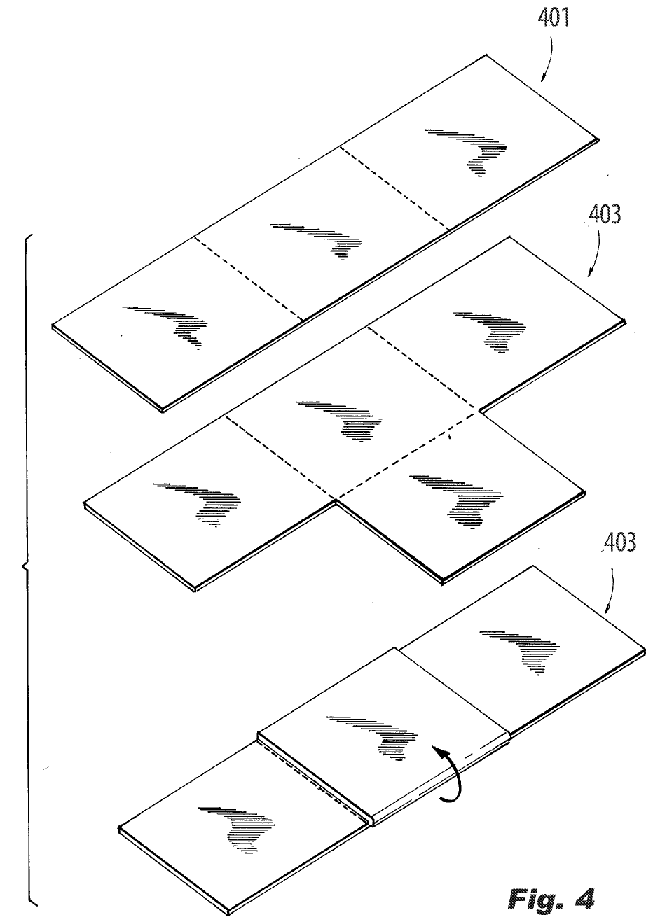

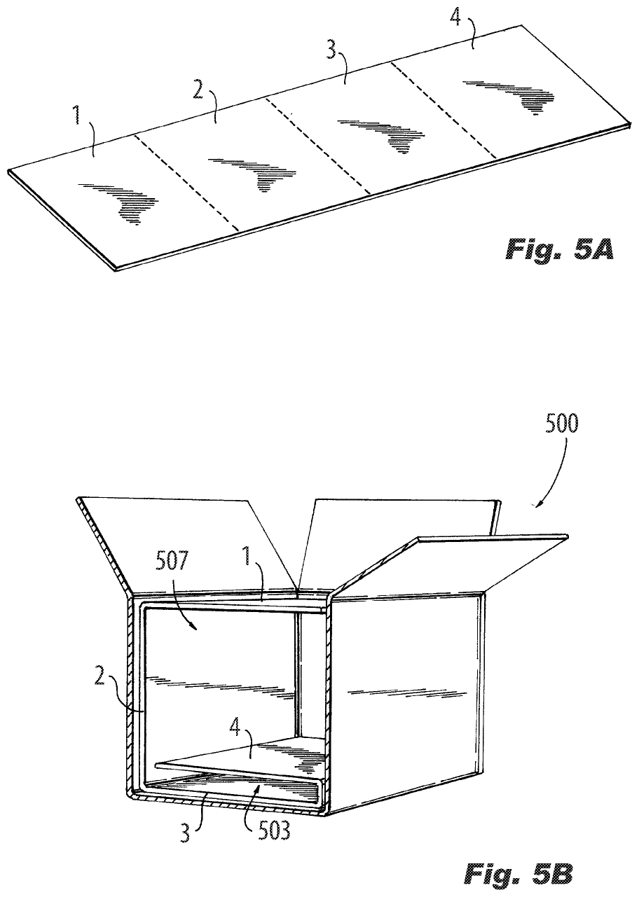

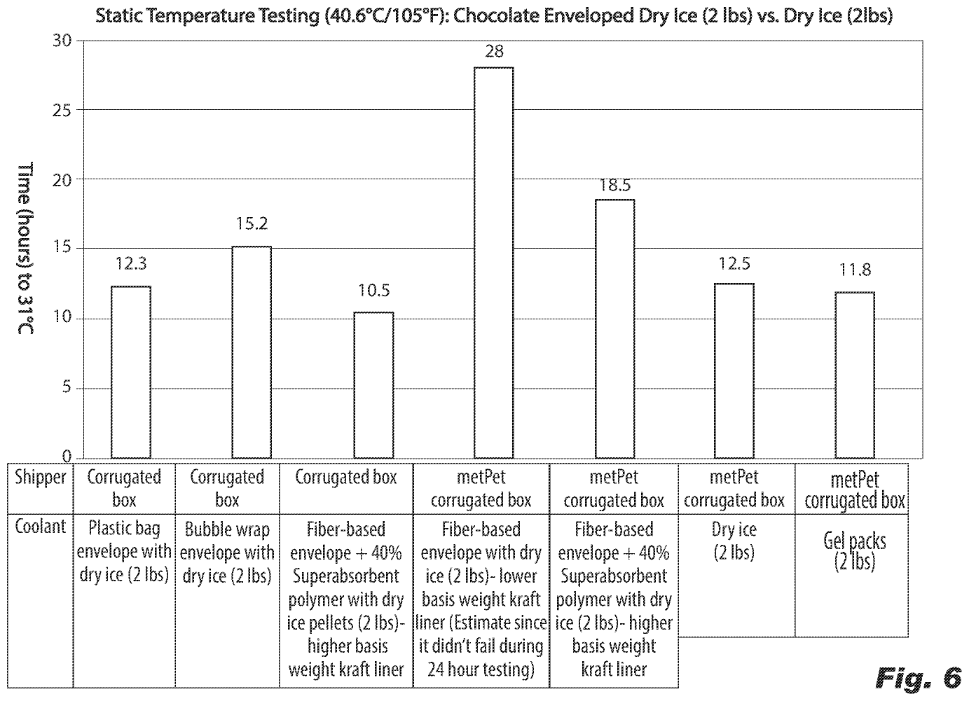

In certain embodiments, the insulating material 107 can be natural and/or synthetic materials, e.g. cellulose insulation, recycled cellulose insulation, plastic, PET, Styrofoam, etc. For example, the insulating material 107 can be fluff pulp (e.g., nonwoven cellulose fibers), e.g., as shown in FIG. 3. For example, embodiments can include a fibrous material as the insulating layer, cellulose fiber insulation, and the liner can be one or more of kraft liner, plastic (e.g., bubble wrap), nylon, and/or corrugated outer casing/liner. Any other suitable insulating material is contemplated herein.

In certain embodiments, the envelope 101a can have a pouch shape, e.g., as shown. In certain embodiments, the envelope 101a can have individually sized components (e.g., tearable pouches to select a number of thermal packages to use in a given shipping package to control a temperature of the shipping package).

In certain embodiments, the thermal regulating device 101 can include the thermal element 303. For example, the thermal element 303 can be dry ice (e.g., a brick of dry ice disposed within the envelope 101a). Any other suitable thermal element 303 is contemplated herein (e.g., a cold pack, a chemical heater). It is contemplated that each envelope 101a and/or each portion thereof can be sold including a fixed amount of dry ice (e.g., in a freezer) and/or can include a metric printed thereon for a user to determine how many envelopes 101a or portions thereof to use to achieve a desired cooling effect (temperature and/or length of cooling time below a certain temperature) for a standardized volume of packaging.

In certain embodiments, the envelope 101a can be configured to control a location of where sublimated gas escapes (e.g., one or more holes on the bottom of the envelope 101a). As shown, the envelope 101a can form at least one opening at an end thereof. The at least one opening can be enclosed using any suitable tape, adhesive, or any other suitable enclosure.

The envelope 101a can be configured such that a time to about 31 degrees C./87.8° F. internal temperature of a shipping container 109, 209 (e.g., a corrugate box, an insulated box) containing the envelope 101a having two pounds of dry ice disposed in the envelope when the shipping package (e.g, when enclosing the envelope 101a) is consistently exposed to about 40.6 degrees C./105° F. is greater than 18 hours. This is an unexpectedly longer time to failure than traditional packages. As shown in FIG. 1, the shipping container 109 can include thermal insulation and/or an inner thermal reflective layer 211. In such a case, the time to about 31 degrees C./87.8° F. can be greater than 24 hours (e.g., 28 hours or more).

In certain embodiments, the thermal control device 101a can include an R value greater than about 0.001 ft²·° F.·h/BTU and less than about 10 ft²·° F.·h/BTU. Any suitable R value to allow a controlled thermal transfer from the thermal control device 101a to a package (e.g., to hold the package at a desired temperature), for example, is contemplated herein. For example, an R value above that of basic plastic sheet packaging (of negligible R value of about 0) for dry ice, and below the R value of a vacuum flask.

As described above, as shown in FIGS. 1 and 2, in certain embodiments of the outer liner can be composed of an outer kraft liner with an inner fiber-based fiberized layer. Embodiments of a package 100, 200 and/or the envelope 101a can be a drop-in cooling agent inside a shipping package (e.g., a metPET shipper as shown in FIG. 1, a corrugated shipper as shown in FIG. 2). In certain embodiments, the package 100, 200 can include the shipping container 109, 209 having the envelope 101a disposed therein. In certain embodiments, the package 100, 200 can be the envelope 101a alone. FIG. 3 shows an opening of the envelope 101a composed of an outer kraft liner with an inner fiber-based fiberized layer encompassing dry ice. As disclosed above, the envelope can be sealed from the top by an adhesive, for example. Certain embodiments can be completely sealed, e.g., where not using subliming coolant, but can have some gas path or permeability to allow gas to escape (e.g., to avoid expansion of the envelope). Any suitable arrangement is contemplated herein.

FIG. 3C shows an embodiment of a configuration of a shipper typically in the ambient or warm range. It incorporates a box (middle), a thermal control device (e.g., 101) encasing a thermal element to the right of box) and the product requiring temperature hold (right end of FIG. 3C). A view of the assembly is shown in the left of FIG. 3C.

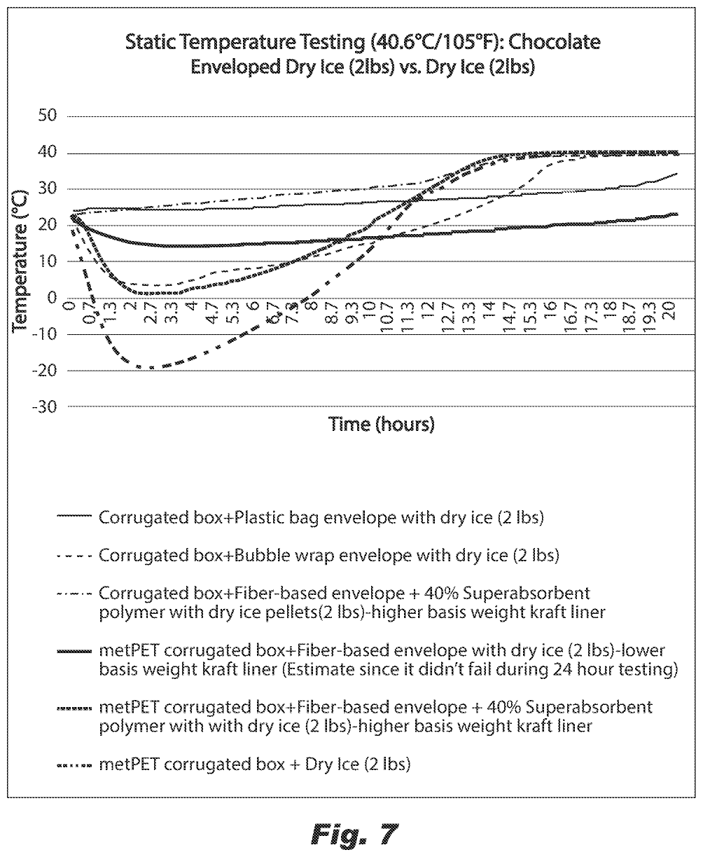

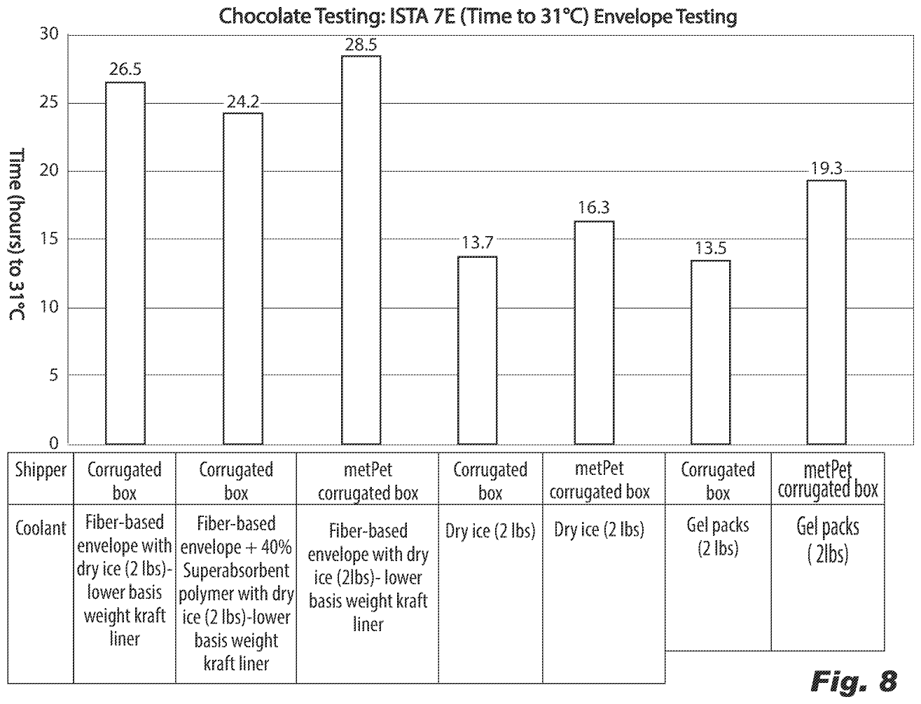

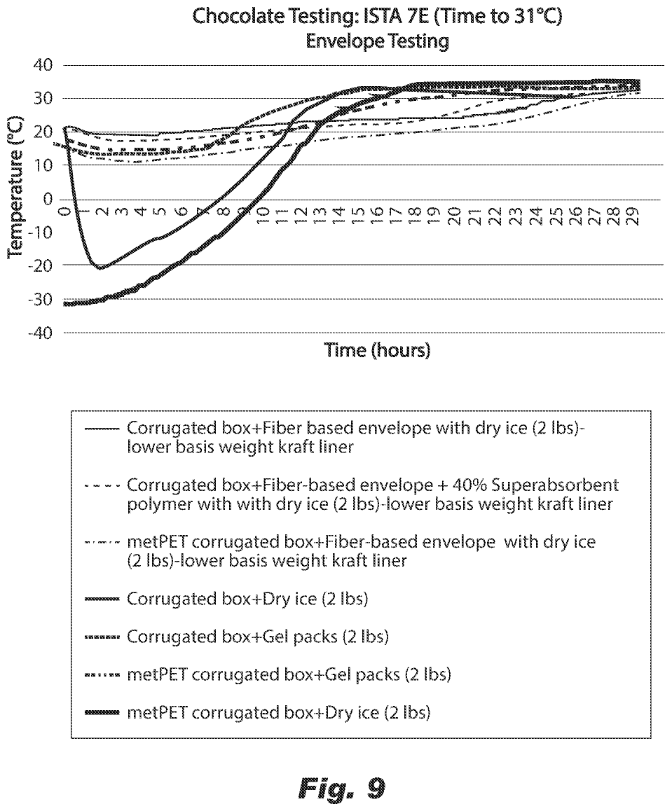

FIG. 3D shows an embodiment of a configuration of a shipper typically in the refrigerated, frozen, or hot range. It incorporates a box (second from left), box insulation (fourth and fifth from left), an thermal control device (e.g., 101) encasing a thermal element (second from right) and the product requiring temperature hold (right end of FIG. 3D). A view of the assembly is shown in the left of FIG. 3D. Referring additionally to FIGS. 4, 5A, and 5B, in accordance with at least one aspect of this disclosure, a package, e.g., 500 can include a first volume 501 for storing an item to be shipped (e.g., a food item), and a second volume 503 divided from the first volume 501 by at least one wall (e.g., panel 4 as shown in FIGS. 5A and 5B). The second volume 503 can be configured to retain a thermal element (e.g., a dry ice brick between panels 3 and 4) to reduce an amount of dead space surrounding the thermal element. The package 500 can include the thermal element (e.g., as disclosed above). In certain embodiments, the second volume 503 is configured to reduce sublimation of the dry ice brick (e.g., by eliminating or reducing dead space). The second volume 503 can be sealed in any suitable manner.

Referring to FIG. 4, and alternative design for an encasement material is shown that can be used as both the encasement layer as well as full or partial insulation within a shipping package. A first C-pad 401 (e.g., having 3 panels) and a second C-pad (e.g., having a fourth flap configured to fold over a middle panel) can be folded and inserted into a shipping package to provide insulation and retain the thermal element. For example, the extra flap on the second C-pad 403 can fold over and cover a dry ice brick to sandwich the dry ice brick. This extra flap can be adhered, taped, or otherwise attached or sealed to the other panels of the second C-pad to retain and/or seal in the thermal element and reducing or eliminating dead space. This assembly can then be inserted into the shipping container, for example.

Referring to FIGS. 5A and 5B, a four panel design of encasement material can be used as both the encasement layer as well as full or partial insulation within a shipper, for example. The embodiment of FIG. 5A can be similar to the embodiment of FIG. 4, but instead of a T-shaped structure, the C-pad can have a fourth flap in a line (e.g., with panels 1, 2, 3, and 4, which can be folded over and attached to cover and retain the thermal element. Any other suitable assembly is contemplated herein. Embodiments of a package can include any suitable materials, coatings, and/or components as appreciated by those having ordinary skill in the art for any suitable application (e.g., food transport, medicine transport, etc.).

A method can include insulating a thermal element within an insulated package, placing the insulated package within a shipping container to regulate a temperature within the shipping container for at least a predetermined amount of time. The thermal element can be dry ice, for example. Placing the insulated package can include placing the insulated package at a bottom of the shipping container. The method can include any other suitable method(s) and/or portions thereof.

As described above, embodiments can provide a target temperature based on amount of insulation and/or other thermal properties of material surrounding the thermal element. Embodiments control the flow of heat to/from the coolant/heater to the surrounding package volume. The thermal packaging for a thermal element can be selected (e.g., more or less insulation, thickness of liner, holes in liner and/or insulation) to provide a predetermined heat transfer between the thermal element and the package volume to produce a predetermined temperature range or value in the package volume. Embodiments can reduce heat transfer to the thermal element and greatly extend the life of the thermal element to cool or heat a shipping package volume to the desired temperature range or value.

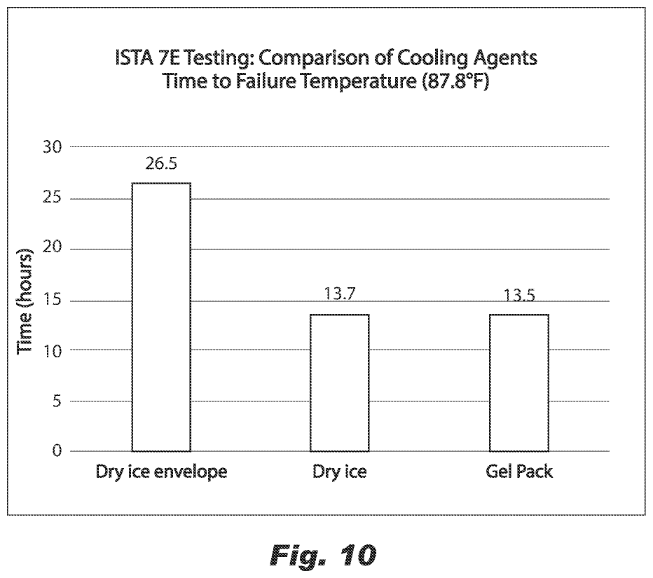

Referring to FIGS. 6-16, experimental results are shown indicating unexpected results with dramatically improved performance over traditional systems. FIG. 6 shows results of a static temperature hold at 40.6° C./105° F. outside temperature, testing a time it takes to reach 31 C/87.8° F. internal temperature of the package. FIG. 6 shows a drastic improvement of product lifetime (more than doubling) with the incorporation of an encased dry ice pack (e.g., using an insulated envelope 101a). As shown, the envelope with dry ice in it more than doubles the lifetime of the dry ice in the metPet box (which has reflective material).

FIG. 7 shows results of a static temperature hold at 40.6° C./105° F., which show a drastic improvement of product lifetime with the incorporation of an encased dry ice pack. Additionally, results display a more controlled temperature profile when cooling the product with dry ice. This is the same test as in FIG. 6, but indicating that embodiments of this disclosure hold a steady temperature range throughout their lifetime. Longevity can be a function of both seal quality and thermal insulation amount, whereas a tightness of the temp range may be a function of primarily thermal transfer of the envelope, for example.

FIG. 8 shows results of dynamic testing, which show a drastic improvement of product lifetime with the incorporation of an encased dry ice pack. A difference between this test and the test of FIGS. 6 and 7 is that the external temperature is not held constant, but is ramped from 82 F to 90 F up and down per a standard accepted test in the industry. FIG. 9 show results of dynamic testing, which show a drastic improvement of product lifetime with the incorporation of an encased dry ice pack. Additionally, these results display a more controlled temperature profile when cooling the product with dry ice. FIG. 9 is the same test as FIG. 8, showing consistent temperature range even with different test type.

FIG. 10 shows results for temperature vs. time comparing cooling agents. This graph represents a time to failure temperature (e.g., 87.8° F. for ambient applications) vs. cooling agents. The dry ice envelope doubles the lifetime of the product during environmental testing. FIG. 11 represents the performance during testing comparing temperature vs. time. Not only does the envelope double the lifetime, but it holds the temperature curve steady in between 60° F. to 80° F. Such control keeps a product from freezing as well as melting, for example. FIG. 11 shows a comparison of cooling agents holding the shipping container constant (corrugated box). The following cooling agents were compared: dry ice alone, gel pack alone and dry ice encompassed in an insulative envelope. The dry ice encompassed in an insulative envelope survived (held under failure temperature of 87.8° F.) twice as long as the lifetime of dry ice alone and gel pack alone. The dry ice encompassed in an insulative envelope survived 25+ hours while the dry ice alone and gel packs alone survived only about 13 hours during ISTA 7E testing.

FIGS. 12A and 12B represents the three thermal applications for cooling (ambient, refrigerated, and frozen). By increasing or decreasing the insulation of the envelope, applying multiple envelopes, and increasing or decreasing the insulation of the shipping package, a proper system for each thermal application can be created. The following configurations were tested for ambient conditions (32° F. to 87.8° F.): corrugated box with Styrofoam (1″) with gel packs (2.8 lbs) (labeled as Current Shipper), metPET box with gel packs (4.2 lbs) (labeled as Partially Sustainable Solution), and metPET box with dry ice encompassed in insulative envelope (4.2 lbs (labeled as Fully Sustainable Solution) All configurations survived 72 hours of ISTA 7E testing (below 87.7° F.), but the curves incorporating gel packs relied on the ramping profile (ISTA temperature curve) to stabilize temperature until 72 hours. If the ISTA temperature curve exceeded the upper limit of temperature it is expected that the gel pack curves would fail much quicker. The solution incorporating the cooling agent encompassed in an insulative envelope not only holds the temperature for an extended time but stabilizes the curve for 50+ hours within a specific window. This ensures that any brief temperature fluctuation has little significant impact on the performance of cooling.

As shown in FIG. 12B, the following configurations were tested for frozen conditions (−50° F. to 32° F.): corrugated box with Styrofoam (1.5″) with dry ice alone (15 lbs) (labeled as Current Shipper), corrugated box with Styrofoam (1.5″) with dry ice encompassed in insulative envelope (15 lbs) (labeled as Improved Performance Solution), and metPET box with metPET insulative (0.5″) with dry ice encompassed in insulative envelope (15 lbs) (Labeled as Fully Sustainable Solution). The dry ice alone curve failed (above 32° F.) within 67 hours of testing. Neither of the other curves failed within 72 hours of testing. Embodiments utilizing an insulative envelope exceeded testing 100+ hours. The as can be seen, certain embodiments survived 74+ hours of testing and provided a more sustainable alternative for material selection (exchanging the Styrofoam insulation for the shipper to metPET alternative at a thinner thickness).

In view of this disclosure, one having ordinary skill in the art can determine, without undue experimentation, how to select a thermal element (e.g., type and amount), thermal packaging characteristics, and shipping packaging characteristics to achieve a predetermined temperature control (e.g., temperature range, rate of cooling or heating) inside the shipping package for a predetermined period of time (e.g., time until failure temperature is reached).

Referring to FIGS. 13-16, in accordance with at least one aspect of this disclosure, a thermal regulating device (e.g., 100) can be configured to contain a thermal element, the device having a substantially linear gravimetric slope of greater than about −0.19 lbs-dry-ice/hour at an atmospheric temperature of 73 degrees F. In certain embodiments, the gravimetric slope can be about −0.085 lbs-dry-ice/hour at an atmospheric temperature of 73 degrees F. The gravimetric slope in a cooler exposed to 73 degrees F. can be about −0.067 lbs-dry-ice/hour.

As shown in FIGS. 13-16, gravimetric testing was conducted from 0 to 2.5 hours in a climate-controlled room (73° F.). The weight of a block of dry ice was measured over a 5-10 minute interval to determine how much dry ice sublimated over time with the following configurations: dry ice block alone, dry ice block encased in 1″ thick envelope, dry ice block alone inside a 14″×11.5″12.5″ cooler (EPS 1″ thick), dry ice block encased in 1″ thick envelope inside a 14″×11.5″12.5″ cooler (EPS 1″ thick), and a dry ice block encased in 0.0023″ plastic wrap.

Configurations that did not include encasing the dry ice with an insulative layer had much steeper slopes than those incorporating an insulative layer. After measurements were taken, a linear regression was found to predict time to complete sublimation (0 lbs of dry ice). Results are shown in FIG. 16. Dry ice alone in the cooler is predicted to last up to 11 hours, while the dry ice encased in the envelope inside the cooler is predicted to last up to 31 hours based on the extended linear regression curves.

Extended the linear regression trendlines predict the time when dry ice is completely sublimated. Dry ice alone is predicted to last up to 4.3 hours, dry ice in plastic wrap is predicted to last up to 6.5 hours and dry ice encased in an insulated envelope is predicted to last up to 24.5 hours, unexpectedly. Predicted time to complete sublimation was found first by adjusting linear regression equations to start at the same weight (y-intercept=2 lbs). Finally, predicted time to complete sublimation was found by holding y=0 for the adjusted equations and converting from minutes to hours.

By incorporating an insulative layer encasing the dry ice, predicted time to complete sublimation was 5.4 times greater than dry ice alone and 3 times greater than dry ice encased in plastic wrap, respectively. The predicted time for complete sublimation for dry ice encased in an envelope inside a 1″ thick cooler was 2.8 times greater than dry ice alone in a 1″ thick cooler. Comparing 14″×11.5″12.5″ cooler (EPS 1″ thick) vs. 12″×10″×3″ insulated envelope (1″ thick), the dry ice encased in an insulated envelope lasted 2.2 time longer than dry ice placed inside the cooler.

It can be concluded that there is a significant improvement in reducing the rate of sublimation by encasing dry ice in an insulative layer. This improvement was seen in configurations with and without an insulative cooler. Additionally, when comparing performance between dry ice inside a 1″ thick cooler with substantial dead space vs. a 1″ thick insulated envelope with minimal dead space performance is significantly improved when dead space is minimized. These results show that insulating dry ice in a configuration with minimal dead space decreases the rate of sublimation thereby increasing the lifetime of cooling during temperature-controlled scenarios.

Embodiments can include an insulated envelope structure with a coolant that can keep a mass cool for a duration of time. Embodiments can include an insulated envelope structure with a heat emitter that can keep a mass warm for a duration of time. Embodiments can include any suitable structure to achieve any desired cooling/heating effect for any desired longevity. Embodiments of a thermal packaging (e.g., an envelope 101a) can be placed in any suitable location in a shipping container. For example, an envelope can be on top of the product (e.g., as shown in FIGS. 3C and 3D), can be below product, can be on one or more sides of the product, can be on top and bottom, can be on the top, the bottom, and sides, can be on the top and sides, or can be on the bottom and sides. Insulation thickness of the envelope on top and bottom faces of envelope can have the same or different amount. For example, thickness can very on top vs bottom, and vice versa.

Embodiments of thermal packaging can have a tight seal or a loose seal, or can have one or more openings that allow more cooling/heating quicker. Multiple envelopes can be used, and envelope thermal characteristics and/or seals can be the same or can vary, e.g., one or more for quick cooling and one or more for longer, slower cooling. Embodiments of an envelope can be flexible, semi-rigid or rigid, can include any suitable outer material(s) (e.g., corrugated, plastic, plant-based, synthetic, or non-synthetic), can include any suitable insulation materials (e.g., non-woven fiber cellulose, corrugated, plastic, plant-based, synthetic or non-synthetic), and can have any suitable sealing (e.g., one or more same or different glues and/or adhesives, one or more folding and locking mechanisms that don't require glue, one or more specific sealing mechanisms to keep a user from hurting themselves but also to allow for adhering to the packaging).

Embodiments of an envelope can be placed in shipper/container that can be non-fiber based or fiber based, that can have a reflective layer or no reflective layer that can have an insulative layer. Embodiments can be placed in a shipper/container alone with product or with insulation as well. In certain embodiments, an envelope can be built into the shipper and/or insulation. In certain embodiments, the envelope can be separate from shipper and/or insulation and be configured to drop into the shipper during packout. Embodiments of an envelope can be placed in shipper either contacting product or something holding it above a product (e.g., food), for example. Embodiments can be recyclable and/or compostable.

Embodiments can be applied to control cooling, e.g., to provide a range of temperatures including ambient, refrigerated, and frozen. Embodiments can be applied to control heating, e.g., a range of temperatures including warm and hot. Embodiments can be used in system that recirculates cooling/heating air through shipper. For example, certain embodiments can be corrugated on bottom for thermal circulation, and can incorporate an envelope with a separate structure (e.g., corrugated material) on the bottom of shipper that allows airflow to circulate cooling back to the top of the shipper. Cooling will sink as heat rises, so this would be a system that circulates cooling back to the top. Embodiments can incorporate condensation control with superabsorbent polymers (SAP's) which can help control the performance of the insulation and maintain quality of product being shipped. Embodiments can extend a lifetime of package allowing for longer transit times during shipping and/or can stabilize a temperature curve to control profiles within specific narrowed temperature ranges.

Embodiments of an envelope can be produced by a machine that makes an outer layer into an envelope and then places insulation inside, for example. The process can include machine gluing insulation to an outer layer and then forming the envelope. The process can include a machine to blow/place insulation in between layers and then form envelope, for example. A process for incorporating envelopes into shipper can include using a machine to fill the envelope and to place it into a shipper

Certain embodiments can control cooling from dry ice, which extends the lifetime of dry ice as well as providing safety features from extreme temperatures. This packaging solution can be utilized in shipping temperature sensitive items to keep contents below a target temperature for expected ship times, maintain product integrity, and improve sustainability.

Embodiments can utilize an envelope configuration that holds dry ice during shipment of temperature-sensitive goods. The envelope structure decreases the amount of dead space surrounding dry ice, which decreases the rate of sublimation. Embodiments can also reduce the rate of melting of an ice pack, gel pack, and/or other phase change materials, and can reduce the rate of heat exchange generally (e.g., for loss of heat of a heating element). Embodiments allow the dry ice or other thermal elements to last longer and form a barrier between extreme cooling/heating and the product being shipped, for example.

In accordance with the above disclosure, embodiment can include a liner, e.g., fiber-based, sandwiching a layer of fluff pulp or other fibrous materials that is arranged similar to an envelope or bag. This envelope-like structure can surround dry ice and be placed in a shipper to act as a cooling agent. This structure decreases the amount of dead space surrounding dry ice, which decreases the rate of sublimation (extending the lifetime of the dry ice as well as the product being shipped). The insulative properties of the structure reduce the effects of conduction, which may allow the dry ice to cool the product without freezing at extreme low temperatures. Additionally, it may provide cooling from the dry ice to the product being shipped through a porous structure that allows airflow. The outer liner can be flexible, such as kraft, plastic or nylon materials, or it can be rigid to semi-rigid depending on the requirements for shipment (e.g. firmly fixed to the shipper or flexible drop in solution). The outer liner can either be porous which allows airflow from the dry ice to the product being shipped or thinner caliper to allow cooling by contact. The inner layer (sandwiched layer) may be composed of natural fibers, such as fluff pulp or shredded recycled paper, as well as synthetic fibrous materials. These materials can provide insulative properties that isolate the dry ice from the product as well as provide channels for airflow to cool the product in a controlled manner. Additionally, the sandwiched layer can be an air gap that isolates the dry ice from the product. Instead of cooling by airflow, this air-gap arrangement cools by conduction, for example.

Preliminary testing has shown significant improvements in extending the lifetime of the product through shipment (e.g., extended by 75% or more). Along with improvements in performance, results show that this structure provides the capability of controlling a temperature hold for a duration of time. This can be applied as a safety feature for isolating the dry ice from the product and consumer (e.g. tamper-resistant seal etc) as well as a safety feature for the product that may require a specific temperature range (not above or below a threshold). It's expected that the temperature hold can be modified based on the materials used and thickness, which allows for more or less airflow and/or more or less conduction.

Embodiments can be utilized in shipment and storage of temperature sensitive items and construction of other temporary thermal structures. Embodiments can be applied to a variety of shipments including, e.g., consumables, electronics and pharmaceuticals. Embodiments can provide cooling at controlled temperatures, decrease the rate of sublimation for extended lifetime, can allow temperature holds to be tailored based on the design and type of material and amount used, and padding from the fiberized pad and other design components (e.g. snugness, positioning, etc.) can protect the dry ice block from breaking into smaller pieces which may sublimate faster due to surface area increase.

Embodiments are safe to handle, can lower a mass of dry ice and still result in similar performance of a larger amount of dry ice without the envelope (e.g. reaching more than 24 hours of use without doubling or tripling the amount of dry ice). Using a lower mass of dry ice can also lead to reduced shipping costs by reducing the weight of a shipment being shipped related to weight and volume of dry ice. This allows the coolant to be utilized more efficiently, thus the coolant could last longer and keep the shipment cool longer. Additionally, if less dry ice can be used, the cost of dry ice would be reduced. Embodiments perform better than gel packs and dry ice alone, can be made of recyclable material, and can remove the burden of returning or storing extra gel packs from e-commerce shipments. Any other suitable uses and/or advantages are contemplated herein.

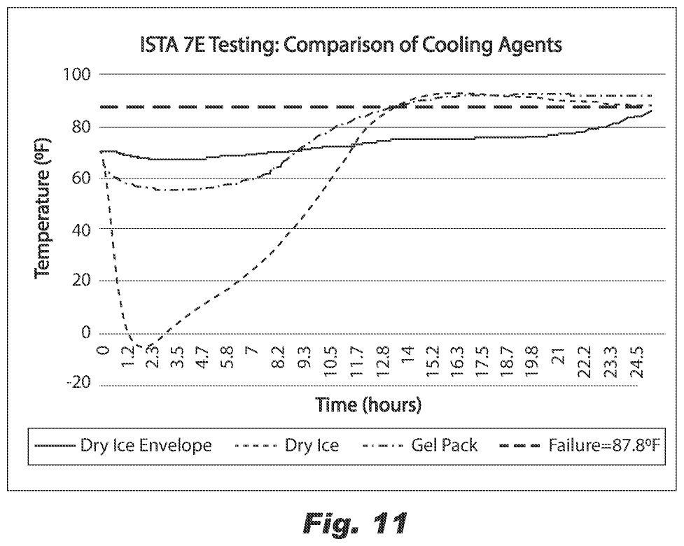

Referring to FIGS. 17-23B, embodiments can be configured for condensation mitigation, for example. In accordance with at least one aspect of this disclosure, a thermal regulating device (e.g., device 101) can include an insulated envelope (e.g., in a form as disclosed above, e.g., similar to envelope 101a) configured to contain a thermal element (e.g., dry ice) therein to reduce thermal transfer between the thermal element and the atmosphere. The insulated envelope can include (e.g., be formed by or otherwise include) a condensation barrier configured to block formation of condensation or to absorb condensation. For example, the insulated envelope can include an outer liner and an insulating material disposed within the outer liner. Similar as disclosed above, an amount of the insulating material can be selected to control temperature of the outer liner and/or rate of heat transfer to the thermal element. The liner can be a natural and/or synthetic material, for example. The liner can be a flexible paper liner (e.g., kraft liner). In certain embodiments, the insulating material can be polyethylene (PE) (configured to act as a condensation barrier, e.g., as described above).

FIG. 17 shows a partial cross-sectional view of an embodiment of a condensation barrier 1700. Referring to FIG. 17, in certain embodiments, the condensation barrier 1700 can include a first layer 1701, a second layer 1703, and middle layer 1705 between the first layer 1701 and second layer 1703. The first layer 1701 and second layer 1703 can be a film (e.g., hydrophobic), and the middle layer 1705 can be spun PET fibers, e.g., as shown.

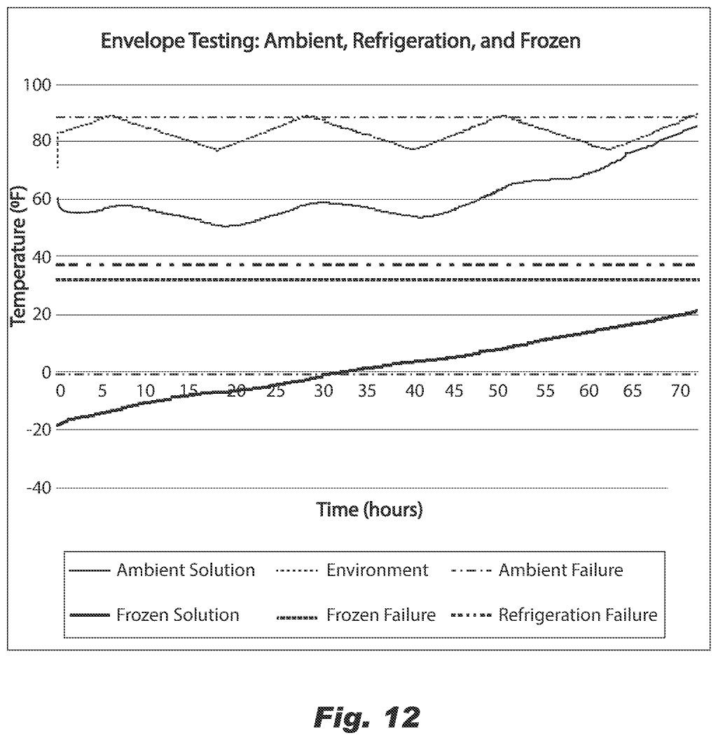

FIG. 18 shows a partial cross-sectional view of an embodiment of a condensation barrier 1800. Referring to FIG. 18, in certain embodiments, the first layer 1801 and second layer 1803 can be coated (e.g., with hydrophobic material) liner (e.g., kraft liner or nylon), and the middle layer 1805 can be corrugated medium (e.g., corrugated paper). For example, the first layer 1801 and the second layer 1803 can include a coating 1801a, 1803a, respectively.

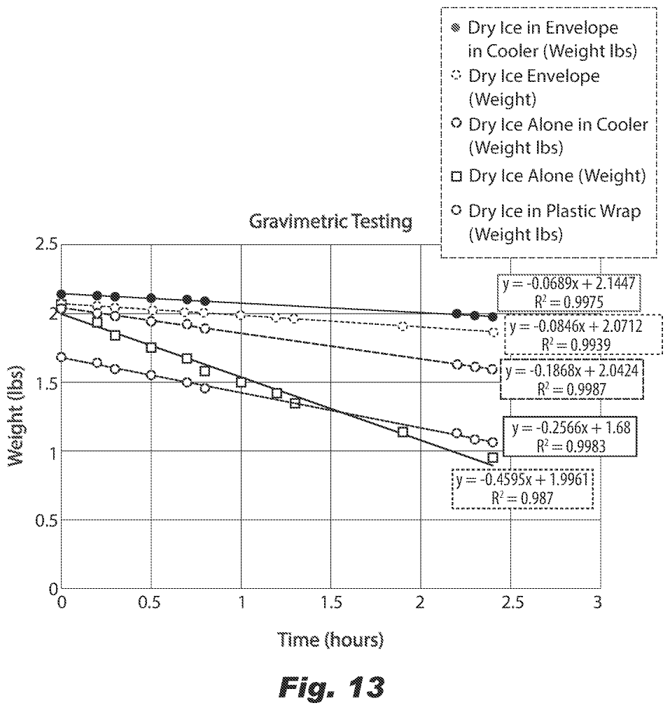

FIG. 19 shows a partial cross-sectional view of an embodiment of a condensation barrier 1900. In certain embodiments, referring to FIG. 19, the first layer 1901 and second layer 1903 can be coated (e.g., with hydrophobic material) liner, e.g., similar to first layer 1801 and second layer 1803 described above. The middle layer 1905 can be a fiberized insulating material, e.g., as shown. Any other suitable sandwich assembly to provide a condensation barrier is contemplated herein.

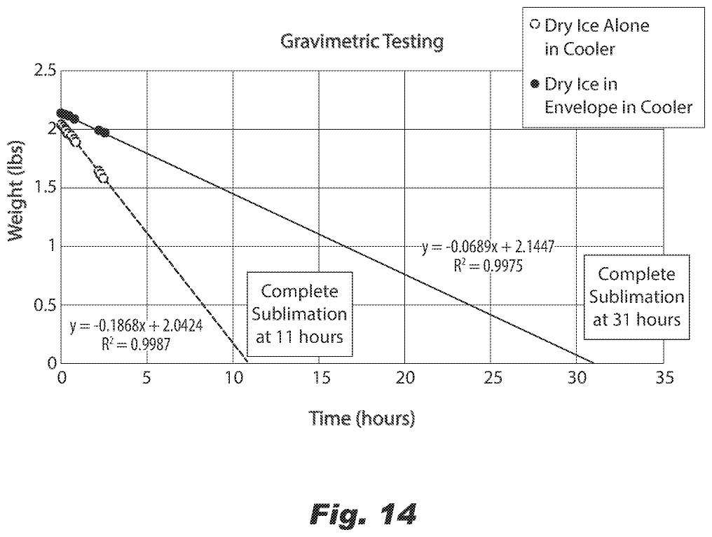

In certain embodiments, the insulating material and/or the outer liner can be the condensation barrier, for example. FIG. 20 shows a partial cross-sectional view of an embodiment of a condensation barrier 2000. In certain embodiments, the insulating material 2001 forming the condensation barrier 2000 is a polyethylene (PE) foam 2001. As shown in FIG. 20, the condensation barrier 2000 can be the insulating material 2001.

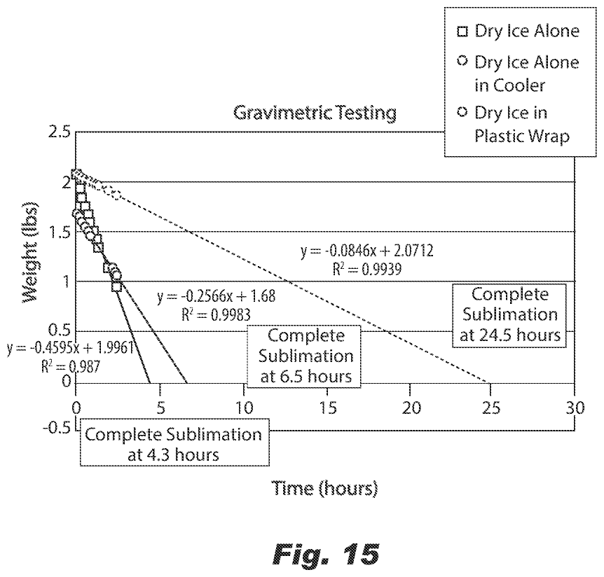

FIG. 21 shows a partial cross-sectional view of an embodiment of a condensation barrier 2100. The condensation barrier 2100 can be a condensation absorbing layer. The condensation absorbing layer can include a first liner 2101, a second liner 2103, and an absorptive material 2105 disposed between the first liner 2101 and the second liner 2103. In certain embodiments, the absorptive material 2105 can include a superabsorbent polymer (SAP). Any suitable SAP(s) appreciated by those having ordinary skill in the art is contemplated herein.

Embodiments of a condensation barrier 2100 can be used with or form a thermal regulating device (e.g., as disclosed above). The thermal regulating device can include any other suitable characteristics of any suitable embodiment(s) disclosed herein, e.g., described above.

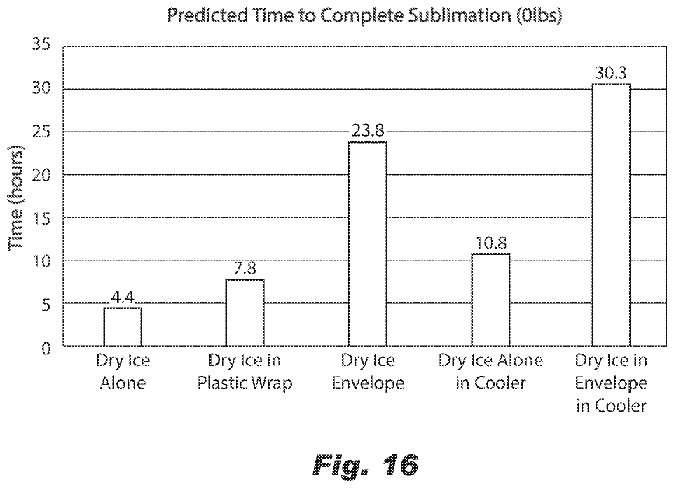

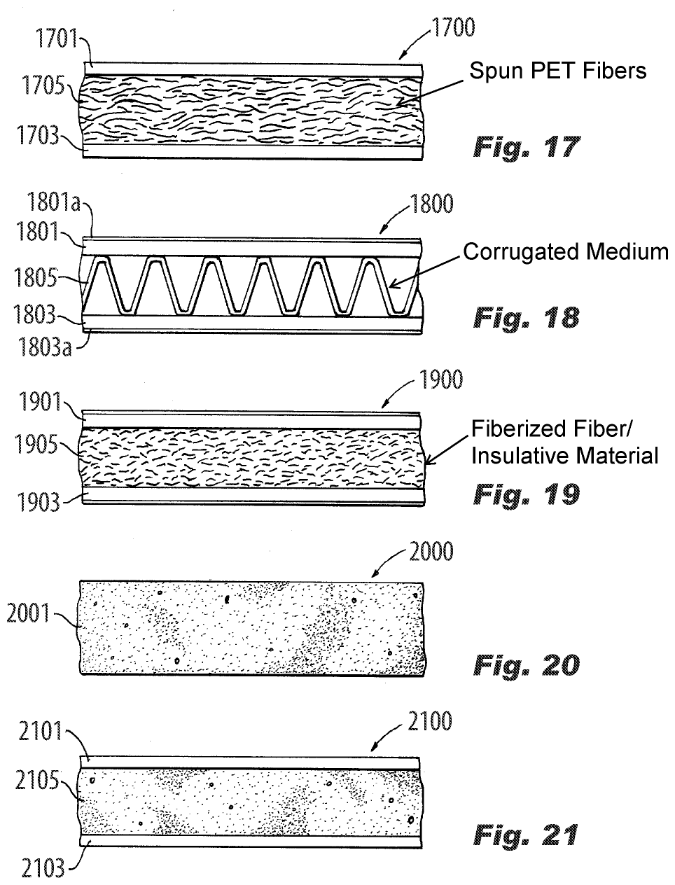

FIG. 22A shows a perspective view of an embodiment of an envelope 2200 made of the embodiment of a condensation barrier 1700 of FIG. 17. FIG. 22B shows a perspective view of the embodiment of FIG. 22A, showing an opening of the envelope 2200.

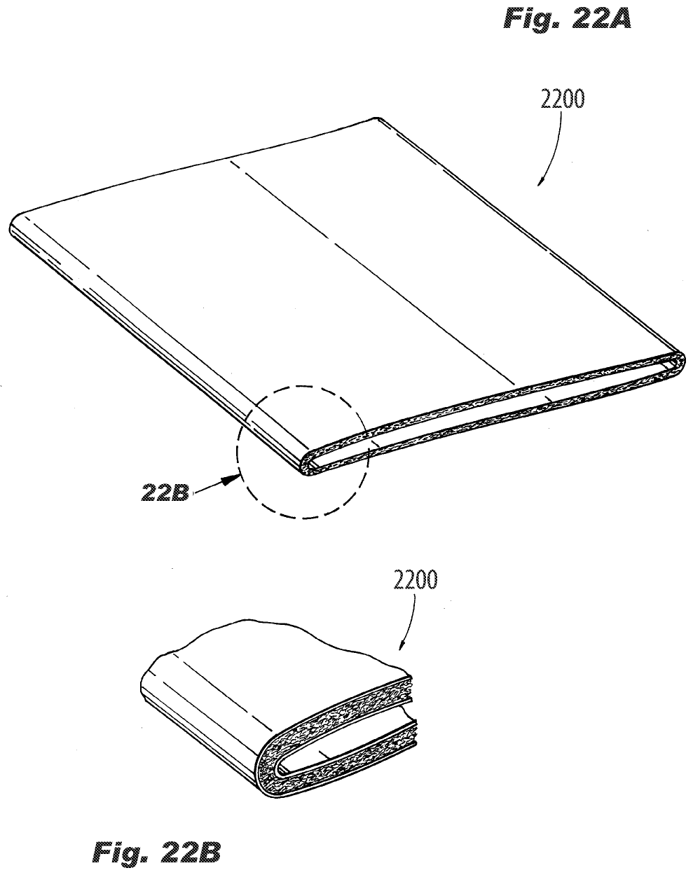

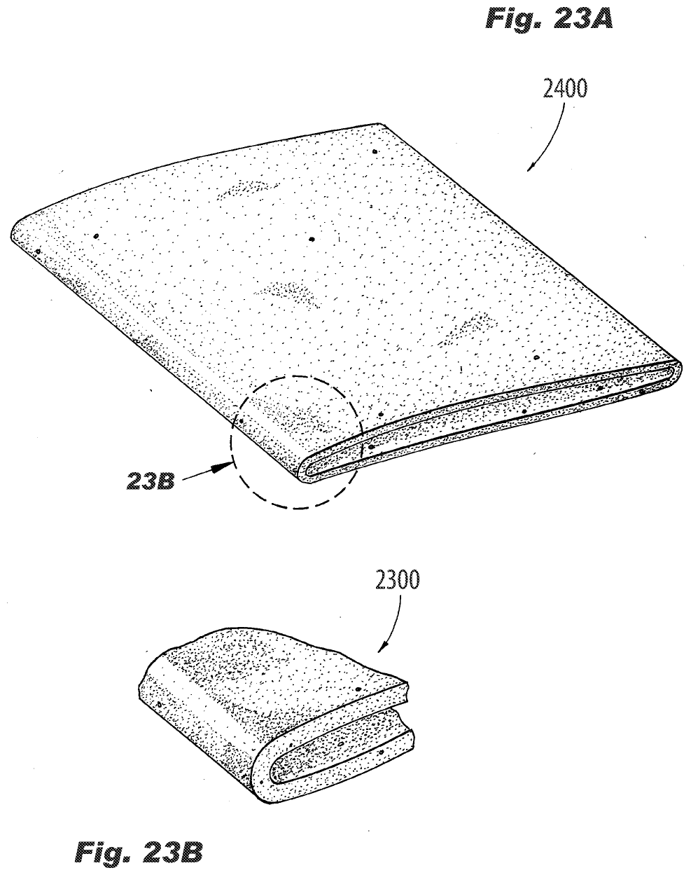

FIG. 23A shows an embodiment of an envelope 2300 made of the embodiment of a condensation barrier 2000 of FIG. 20. FIG. 23B shows a perspective view of the embodiment of FIG. 23A, showing an opening of the envelope 2300.

In accordance with at least one aspect of this disclosure, a method can include insulating a thermal element (e.g., dry ice) within an insulated package having a condensation barrier (e.g., as shown in FIGS. 17-21), and placing the insulated package within a shipping container to regulate a temperature within the shipping container for at least a predetermined amount of time while preventing condensation from forming within the package due to the condensation barrier. The thermal element can be dry ice, for example. Placing the insulated package can include placing the insulated package at a bottom of the shipping container.

Embodiments having a condensation barrier can provide a barrier that protects product being shipped and the shipping box/insulation of the shipping box from condensation due to the thermal element (e.g., due to water condensing on an outside of a cold surface). Embodiments can help maintain the integrity of the packaging for the product as well as the integrity of the shipper.

Condensation can be limited/eliminated using embodiments of this disclosure. For example, a barrier layer between the thermal element and product being shipped can be created. In certain embodiments, a layer with embedded superabsorbent polymers (SAPs) that absorb condensation or humidity can be used to absorb condensation from the thermal element (e.g., dry ice) as well as control humidity within the box. In certain embodiments, a barrier layer between a thermal element (e.g., dry ice) and product being shipped that reduces or eliminates condensation can be used.

The barrier layer can be a coating or film on top or below (or both) of an insulating layer. Examples of this can include a PET spun insulating layer with film on top and bottom (or either), a coated kraft liner board on top and bottom (or either) of corrugated board, and kraft liner coated on top and bottom (or either) with fiberized fiber in between the kraft layers as insulation.

In certain embodiments, the insulating layer can be a barrier and provide insulation. An example can be a PE foam with varying thickness. Certain embodiments can include a structure of expanded pad of cellulose fiber and additives encased in kraft or nylon layer.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

The articles “a”, “an”, and “the” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

Any suitable combination(s) of any disclosed embodiments and/or any suitable portion(s) thereof are contemplated herein as appreciated by those having ordinary skill in the art in view of this disclosure.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A thermal regulating device, comprising:
an insulated envelope configured to contain a thermal element therein to reduce thermal transfer between the thermal element and the atmosphere, wherein the insulated envelope includes a condensation barrier configured to block formation of condensation or to absorb condensation.

2. The device of claim 1, wherein the insulated envelope includes an outer liner and an insulating material disposed within the outer liner, wherein the insulating material and/or the outer liner are the condensation barrier.

3. The device of claim 2, wherein an amount of the insulating material is selected to control temperature of the outer liner and/or rate of heat transfer to the thermal element.

4. The device of claim 3, wherein the liner is a natural and/or synthetic material.

5. The device of claim 4, wherein the liner is a flexible paper liner.

6. The device of claim 2, wherein the insulating material is polyethylene (PE).

7. The device of claim 2, wherein the condensation barrier includes a first layer, a second layer, and middle layer between the first and second layer.

8. The device of claim 7, wherein the first layer and second layer are a film, wherein the middle layer is spun PET fibers.

9. The device of claim 7, wherein the first layer and second layer are coated liner, wherein the middle layer is corrugated medium.

10. The device of claim 7, wherein the first layer and second layer are coated liner, wherein the middle layer is a fiberized insulating material.

11. The device of claim 1, wherein the condensation barrier is a condensation absorbing layer.

12. The device of claim 11, wherein the condensation absorbing layer includes a first liner, a second liner, and an absorptive material disposed between the first liner and the second liner.

13. The device of claim 12, wherein the absorptive material is a superabsorbent polymer.

14. The device of claim 1, wherein the envelope is configured such that a time to about 31 degrees C. internal temperature of a shipping container containing the envelope having two pounds of dry ice disposed in the envelope when the shipping package is consistently exposed to about 40.6 degrees C. is greater than 18 hours.

15. The device of claim 14, wherein the shipping container includes thermal insulation and/or an inner thermal reflective layer, wherein the time to about 31 degrees C. is greater than 24 hours.

16. The device of claim 15, further comprising the shipping container having the envelope disposed therein.

17. The device of claim 1, further comprising the thermal element, wherein the thermal element is dry ice.

18. A method, comprising:
insulating a thermal element within an insulated package having a condensation barrier; and
placing the insulated package within a shipping container to regulate a temperature within the shipping container for at least a predetermined amount of time while preventing condensation from forming within the package due to the condensation barrier.

19. The method of claim 18, wherein the thermal element is dry ice.

20. The method of claim 19, wherein placing the insulated package includes placing the insulated package at a bottom of the shipping container.
